(19) United States
(12) Patent Application Publication
(10) Pub. No.: US 2017/0093068 A1
(43) Pub. Date: Mar. 30, 2017

(54) CONNECTOR AND MATING METHOD

(71) Applicant: FUJITSU LIMITED, Kawasaki-Shi (JP)

(72) Inventor: Akira Okada, Kawasaki (JP)

(73) Assignee: FUJITSU LIMITED, Kawasaki-shi (JP)

(21) Appl. No.: 15/264,915

(22) Filed: Sep. 14, 2016

(30) Foreign Application Priority Data
Sep. 25, 2015 (JP) 2015-188020

(51) Int. Cl. H01R 13/03; H01R 12/71; H01R 43/26

(52) U.S. Cl. CPC H01R 13/03; H01R 43/26; H01R 12/716

(57) ABSTRACT

A connector includes a first connector that includes a first terminal; and a second connector that includes a second terminal and is configured to be mated to the first connector, wherein in a state where the first connector and the second connector are mated, the second terminal holds the first terminal and accommodates a leading end part of the first terminal, first metal plating is formed above a portion of the first terminal from a part of the first terminal to a base end part of the first terminal, the part being configured to be held by the second terminal, and the leading end part of the first terminal accommodated in the second terminal is exposed from the first metal plating. The first connector is preferably coupled to a first board and the second connector is coupled to a second board.

### CROSS-REFERENCE TO RELATED APPLICATION

This application is based upon and claims the benefit of priority of the prior Japanese Patent Application No. 2015-188020, filed on Sep. 25, 2015, the entire contents of which are incorporated herein by reference.

### FIELD

The embodiment discussed herein is related to a connector and a mating method.

### BACKGROUND

Due to recent increase in data traffic, frequencies of digital signals in network systems and server systems have become higher, and multiple printed circuit boards equipped with electronic components have been mounted on an electronic apparatus. There is a method for mounding multiple printed circuit boards in a single electronic apparatus, in which the multiple printed circuit boards are electrically coupled with each other through a backboard in the electronic apparatus. Each of the printed circuit board includes a connector which couples a corresponding one of connectors provided on the backboard. The backboard is a wiring board that is also called a back wiring board (BWB).

Related techniques are disclosed in, for example, Japanese Laid-open Patent Publication Nos. 2002-175853 and 2011-82048.

### SUMMARY

According to an aspect of the invention, a connector includes a first connector that includes a first terminal; and a second connector that includes a second terminal and is configured to be mated to the first connector, wherein in a state where the first connector and the second connector are mated, the second terminal holds the first terminal and accommodates a leading end part of the first terminal, first metal plating is formed above a portion of the first terminal from a part of the first terminal to a base end part of the first terminal, the part being configured to be held by the second terminal, and the leading end part of the first terminal accommodated in the second terminal is exposed from the first metal plating.

According to another aspect of the invention, a connector includes a first connector that includes a first terminal and is mounted above a first board; and a second connector that includes a second terminal, is mounted above a second board, and is configured to be mated to the first connector, wherein in a state where the first connector and the second connector are mated, the second terminal holds the first terminal and accommodates a leading end part of the first terminal, first metal plating is formed above a portion of the first terminal from a part of the first terminal to a base end part of the first terminal coupled to the first board, the part being configured to be held by the second terminal, and the leading end part of the first terminal accommodated in the second terminal is exposed from the first metal plating.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a schematic diagram illustrating an example of an electronic apparatus;

FIG. 2 is a schematic diagram of a connector and a printed circuit board;

FIG. 3 is another schematic diagram of the connector and the printed circuit board;

FIG. 4 is an enlarged view of the connector;

FIG. 5 is another enlarged view of the connector;

FIG. 6 is an enlarged view of a male terminal;

FIG. 7 is an enlarged view of a female terminal;

FIG. 8 is a diagram schematically illustrating a flow of a signal transmitted from a backboard to an electronic component;

FIG. 9 is another enlarged view of the connector;

FIG. 10 is an enlarged view of the male terminal and the female terminal;

FIG. 11 is a schematic diagram illustrating an electronic apparatus according to a comparative example;

FIG. 12 is a schematic diagram of a connector according to the comparative example;

FIG. 13 is another schematic diagram of the connector according to the comparative example; and

FIG. 14 is a diagram schematically illustrating a flow of a signal transmitted by a male terminal and a female terminal according to the comparative example.

### DESCRIPTION OF EMBODIMENT

When the frequency of a digital signal become higher, transmission loss may increase due to influence of signal reflection and the like, so that it may be difficult to recognize a signal in an electronic component on a receiving side. The embodiment herein is intended to provide a technique of suppressing reflection of a signal.

An embodiment will be described below with reference to the drawings. A configuration of the embodiment is an example, and the embodiment is not limited to this configuration.

FIG. 11 is a schematic diagram illustrating an electronic apparatus 901 according to a comparative example. The electronic apparatus 901 includes a backboard 902, connectors 903A and 903B, and printed circuit boards 904A and 904B, as illustrated in FIG. 11. Electronic components 905A and 905B are implemented on the printed circuit boards 904A and 904B, respectively. The printed circuit boards 904A and 904B are mounted on the backboard 902 via the connectors 903A and 903B, respectively. The electronic components 905A and 905B are accordingly capable of communicating with each other via the backboard 902. Wirings 906 for communication are formed on the backboard 902.

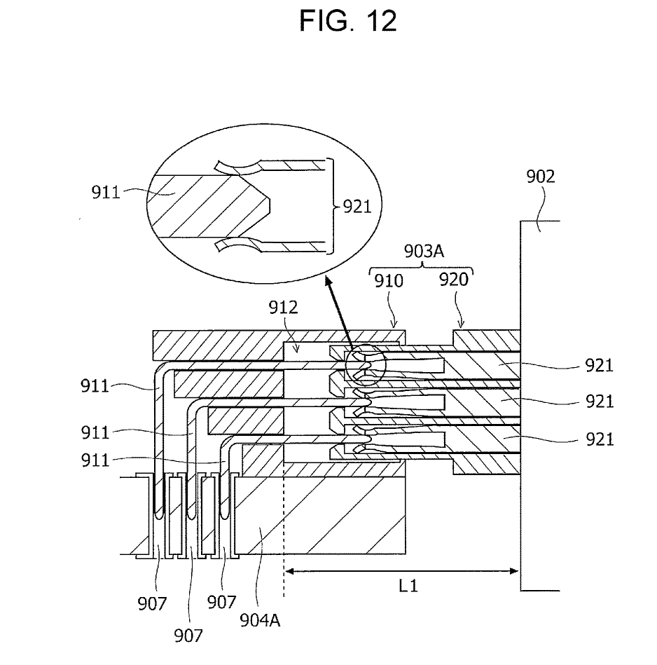

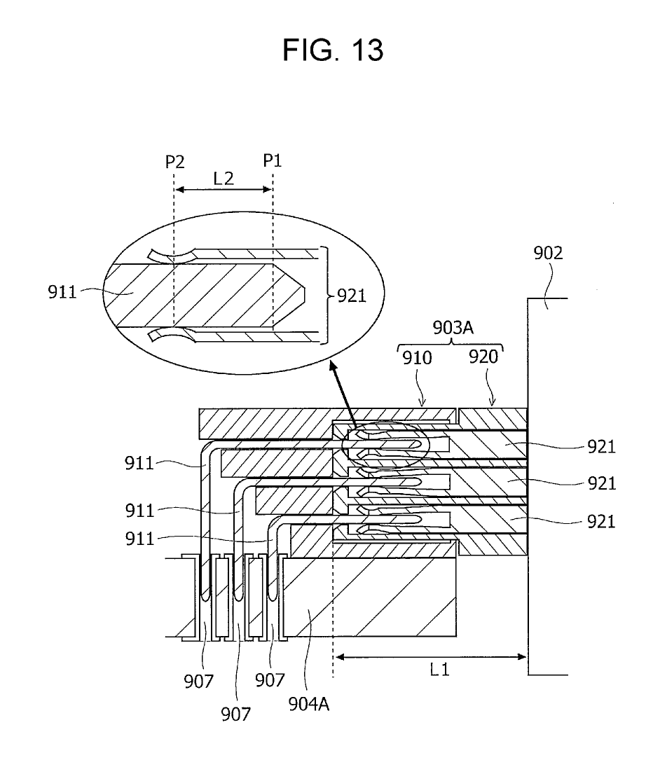

FIGS. 12 and 13 are schematic diagrams of the connector 903A according to the comparative example. The connector 903A includes a male connector 910 and a female connector 920. The male connector 910 includes multiple male terminals 911. Each of the male terminals 911 is inserted into a corresponding through hole 907 formed in the printed circuit board 904A, while passing through the male connector 910. The female connector 920 includes multiple female terminals 921. The male terminals 911 and the female terminals 921 are each formed of a conductive material. FIG. 12 illustrates a state where contact between the male terminal 911 and the female terminal 921 begins, upon start of mating of the male connector 910 and the female connector 920. FIG. 13 illustrates a state where mating of the male connector 910 and the female connector 920 is completed.

A length L1 illustrated in FIGS. 12 and 13 is a length from a bottom of an opening 912 of the male connector 910 to a rear end of the female terminal 921. In the state where mating of the male connector 910 and the female connector 920 begins (the state illustrated in FIG. 12), the length L1 is 16.9 mm. In the state where mating of the male connector 910 and the female connector 920 is completed (the state illustrated in FIG. 13), the length L1 is 14.0 mm. A length L2 from a position P1 (a position where the contact between the male terminal 911 and the female terminal 921 begins) to a position P2 (a position where the male terminal 911 and the female terminal 921 are in contact with each other in the state where mating of the male connector 910 and the female connector 920 is completed) is 2.9 mm (=16.9 mm−14.00 mm).

In the state where mating of the male connector 910 and the female connector 920 is completed, a part from the position P1 to the position P2 in the male terminal 911 is a part as an electrical branch. To avoid the electrical branch in the male terminal 911, it is conceivable to change the length L2 in the male terminal 911 from 2.9 mm to 0 mm. However, when the length L2 in the male terminal 911 is 0 mm, the male connector 910 and the female connector 920 may not be mated due to various variations such as warping of boards and assembly tolerance. Therefore, it is difficult to change the length L2 in the male terminal 911 from 2.9 mm to 0 mm. In consideration of warping of boards and mechanical deviation, the length L2 in the male terminal 911 is preferably about 1 mm to 2 mm.

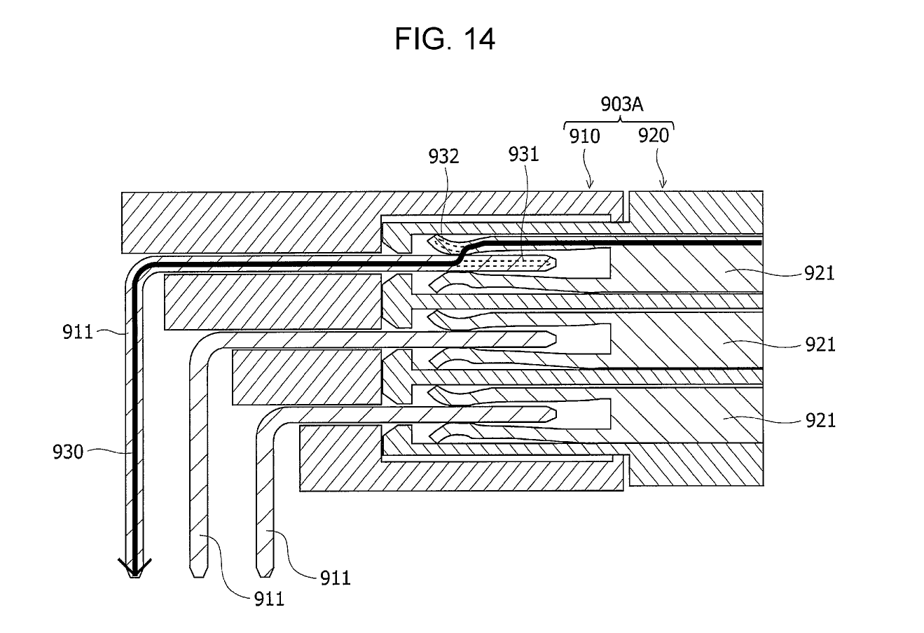

FIG. 14 is a diagram schematically illustrating a flow of a signal transmitted through the male terminal 911 and the female terminal 921 according to the comparative example. In FIG. 14, the flow of the signal is indicated by a bold line 930 as well as dotted lines 931 and 932. A branch of a signal path occurs at each of a leading end part of the male terminal 911 and a leading end part of the female terminal 921 and thus, reflection of the signal occurs at each of the leading end part of the male terminal 911 and the leading end part of the female terminal 921. Therefore, the connector 903A according to the comparative example has such an issue that reflection occurs in the signal transmitted through the male terminal 911 and the female terminal 921, and noise due to the reflection of the signal and the like occurs, which degrades transmission quality of the signal transmitted through the male terminal 911 and the female terminal 921.

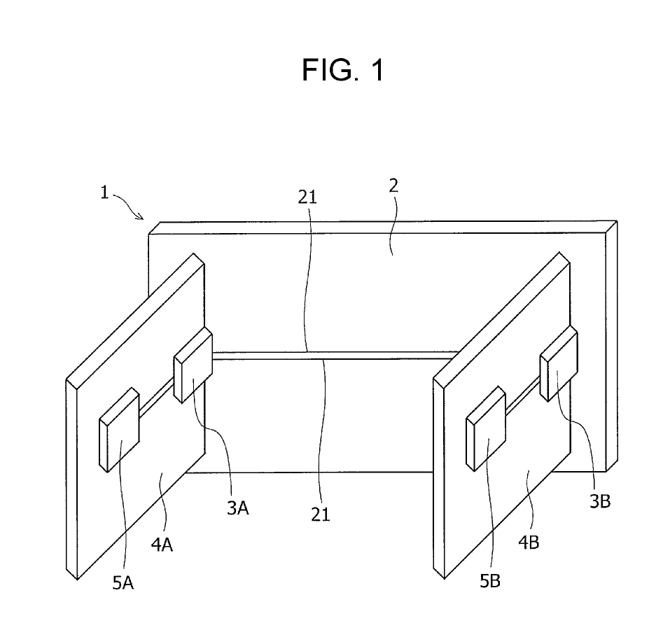

A connector and a mating method according to an embodiment will be described with reference to FIGS. 1 to 10. FIG. 1 is a schematic diagram illustrating an example of an electronic apparatus 1. The electronic apparatus 1 includes a backboard 2, connectors 3A and 3B, and printed circuit boards 4A and 4B. The electronic apparatus 1 is, for example, a server, a router, a disk array device, or the like. An electronic component 5A is implemented on the printed circuit board 4A, and an electronic component 5B is implemented on the printed circuit board 4B. The printed circuit board 4A is mounted on the backboard 2 via the connector 3A. The printed circuit board 4B is mounted on the backboard 2 via the connector 3B.

The backboard 2 is a wiring board which is also referred to as BWB. The backboard 2 is an example of a second board. The connectors 3A and 3B are each also referred to as an inter-board connector. The electronic component 5A includes a transmitting circuit and a receiving circuit. The electronic component 5B includes also a transmitting circuit and a receiving circuit. The electronic components 5A and 5B are capable of communicating with each other via the backboard 2. On the backboard 2, wirings 21 for communication are formed.

The connector 3A and the connector 3B may be hereinafter collectively referred to as the connector 3. The printed circuit board 4A and the printed circuit board 4B may be hereinafter collectively referred to as the printed circuit board 4. The electronic component 5A and the electronic component 5B may be hereinafter collectively referred to as the electronic component 5. The printed circuit board 4 is an example of a first board.

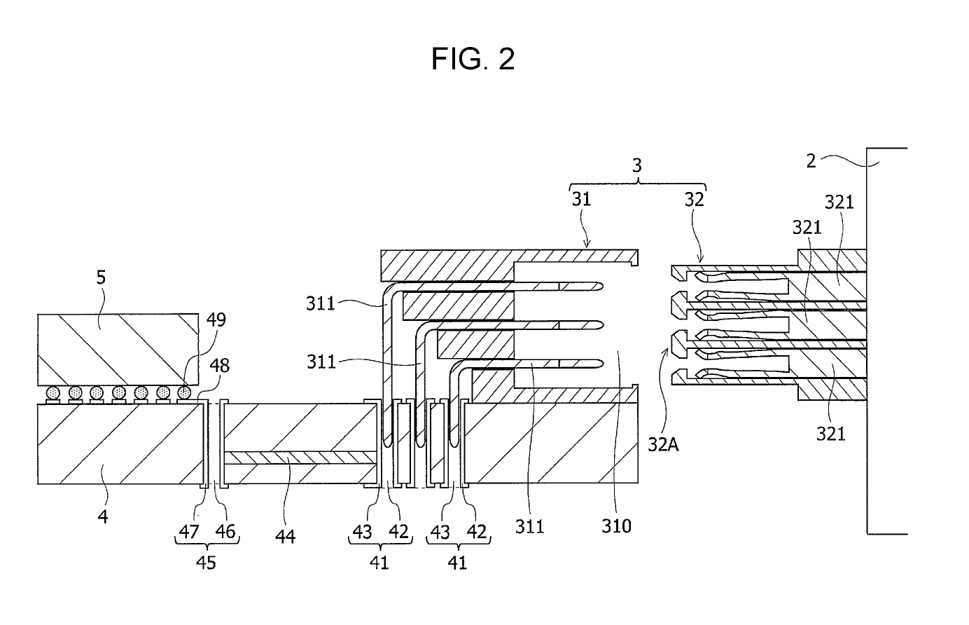

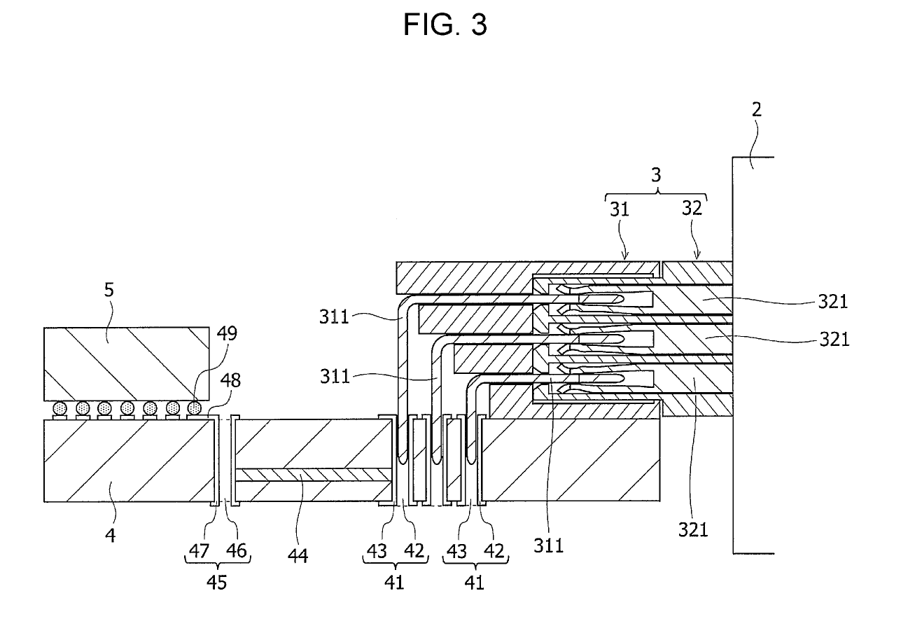

FIGS. 2 and 3 are schematic diagrams each illustrating the connector 3 and the printed circuit board 4. The connector 3 includes a male connector 31 and a female connector 32. The male connector 31 is mounted (implemented) on the printed circuit board 4. The female connector 32 is mounted (implemented) on the backboard 2. FIG. 2 illustrates the connector 3 in a state before mating of the male connector 31 and the female connector 32. FIG. 3 illustrates the connector 3 in a state where mating of the male connector 31 and the female connector 32 is completed. The male connector 31 is an example of a first connector. The female connector 32 is an example of a second connector.

The male connector 31 includes multiple male terminals (leads) 311. The multiple male terminals 311 pass through the male connector 31. A first end part (one end) of each of the male terminals 311 projects from an opening 310 formed at a front end part of the male connector 31. A second end part (the other end) of the corresponding male terminal 311 is formed to project from a rear end part of the male connector 31, and inserted into a corresponding through hole 41 formed in the printed circuit board 4. The through hole 41 has an aperture 42 passing through the printed circuit board 4 and a metal layer 43 formed on a sidewall of the aperture 42 passing through the printed circuit board 4. The printed circuit board 4 includes the multiple through holes 41.

The through hole 41 is connected to a through hole 45 via wiring 44 formed inside the printed circuit board 4. The through hole 45 has an aperture 46 passing through the printed circuit board 4 and a metal layer 47 formed on a sidewall of the aperture 46 passing through the printed circuit board 4. The through hole 45 is connected to a land (an electrode) 48 formed on a top surface of the printed circuit board 4. A solder ball 49 is disposed on the land 48. The solder ball 49 is joined to an electrode (not illustrated) of the electronic component 5. Although not illustrated in FIGS. 2 and 3, the printed circuit board 4 includes the multiple through holes 45 and the multiple lands 48.

The female connector 32 includes multiple female terminals 321. By insertion of a leading end part 32A of the female connector 32 into the opening 310 of the male connector 31, mating of the male connector 31 and the female connector 32 begins.

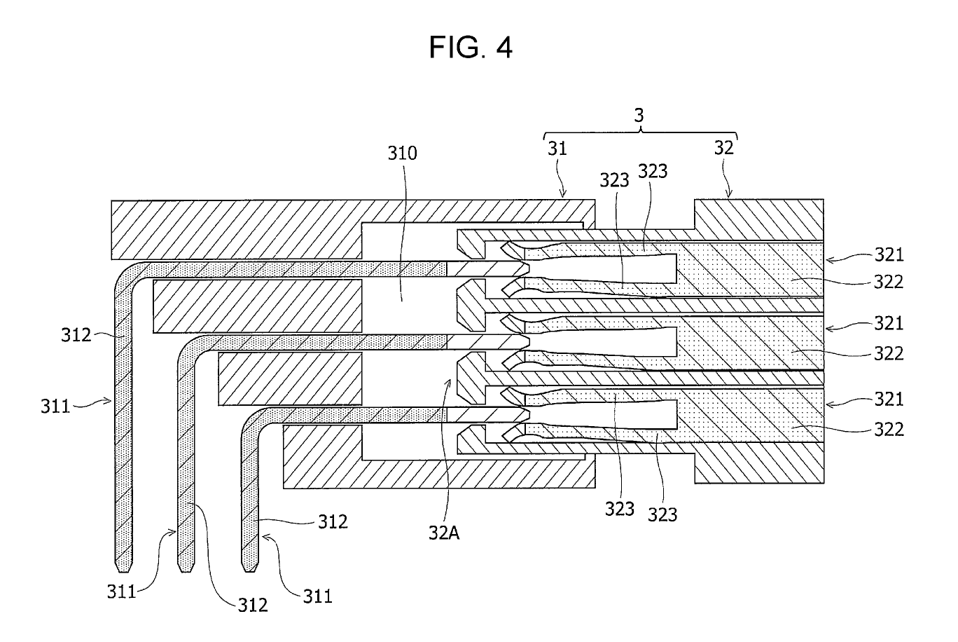

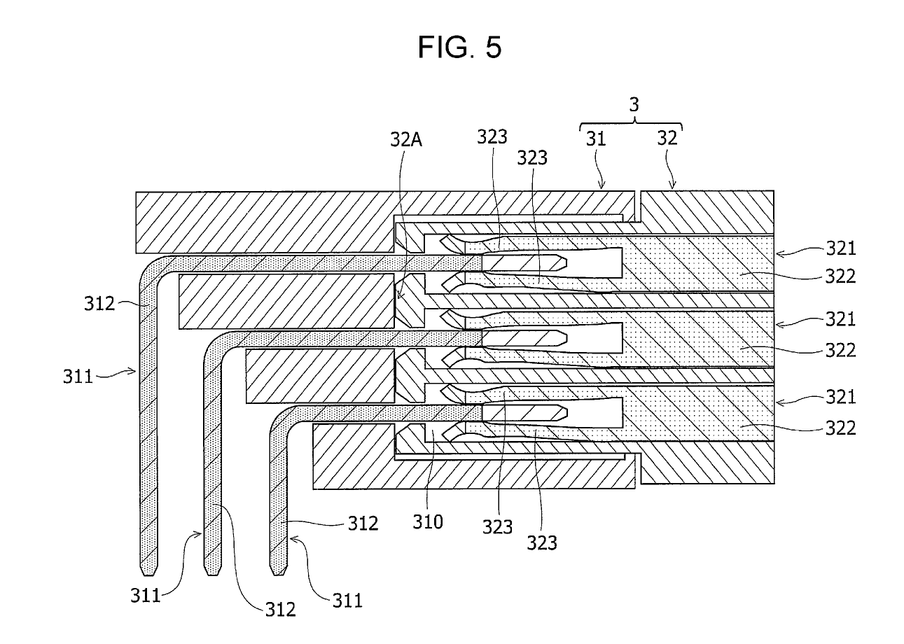

FIGS. 4 and 5 are enlarged views of the connector 3. A material of the male terminal 311 is a nonconductive material. Examples of the nonconductive material include nonconductive resin such as Acrylonitrile Butadiene Styrene (ABS) resin and fiber reinforced plastics (FRP), for example. On a part of a surface of the male terminal 311, metal plating 312 is formed. Examples of the metal plating 312 include Au plating and Ni plating, for example. The metal plating 312 may be formed on the surface of the male terminal 311 by, for example, electroless plating. The metal plating 312 has a thickness of, for example, 0.1 μm or more and 1.0 μm or less.

A material of the female terminal 321 is a nonconductive material. Examples of the nonconductive material include nonconductive resin such as ABS resin and FRP, for example. On a part of a surface of the female terminal 321, metal plating 322 is formed. Examples of the metal plating 322 include Au plating and Ni plating, for example. The metal plating 322 may be formed on the surface of the female terminal 321 by, for example, electroless plating. The metal plating 322 has a thickness of, for example, 0.1 μm or more and 1.0 μm or less.

The female terminal 321 includes a pair of grippers 323 provided to hold the male terminal 311. The grippers 323 extend in the longitudinal direction of the female terminal 321, and curve to be close to each other. The female terminal 321 holds the male terminal 311 by sandwiching the male terminal 311 with curved sections of the respective grippers 323.

When the leading end part 32A of the female connector 32 is inserted into the opening 310 of the male connector 31, the male terminals 311 face the respective female terminals 321. As illustrated in FIG. 4, the leading end part 32A of the female connector 32 moves deeper inside the opening 310 of the male connector 31, thereby causing a leading end part of the male terminal 311 to be inserted between the pair of grippers 323.

As illustrated in FIG. 5, when the leading end part 32A of the female connector 32 comes in contact with a bottom of the opening 310 of the male connector 31, mating of the male connector 31 and the female connector 32 is completed. In a state where the male connector 31 and the female connector 32 are mated, the female terminal 321 holds the male terminal 311. A state where the male terminal 311 and the female terminal 321 are in contact with each other is maintained by holding of the male terminal 311 by the female terminal 321. Further, in the state where the male connector 31 and the female connector 32 are mated, the female terminal 321 accommodates a part of the male terminal 311. Therefore, in a mating method of causing mating of the male connector 31 and the female connector 32, when the male connector 31 and the female connector 32 are mated, the female terminal 321 holds the male terminal 311, and the female terminal 321 accommodates the part of the male terminal 311.

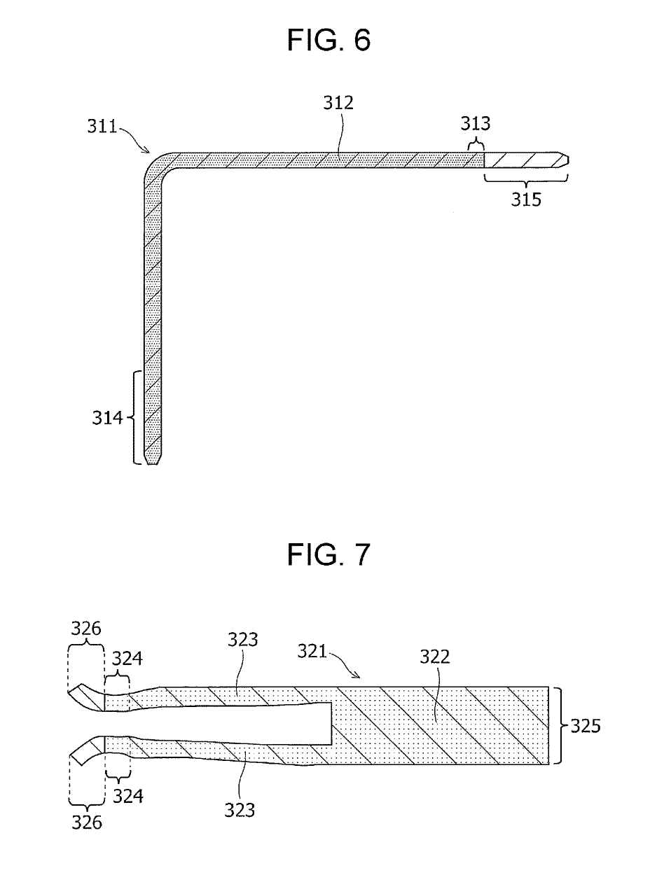

FIG. 6 is an enlarged view of the male terminal 311. In the male terminal 311, the metal plating 312 is formed from a first section 313 of the male terminal 311 to a second section 314 (a base end part) of the male terminal 311. The first section 313 of the male terminal 311 is the part to be held by the grippers 323 of the female terminal 321, in the state where the male connector 31 and the female connector 32 are mated. The second section 314 of the male terminal 311 is a part to be inserted into the through hole 41 of the printed circuit board 4, and be connected to the printed circuit board 4. The metal plating 312 is not formed on a third section (a leading end part) 315 leading from the first section 313 of the male terminal 311. In other words, the third section 315 of the male terminal 311 is exposed from the metal plating 312. The third section 315 of the male terminal 311 is a non-plated part where the metal plating 312 is not formed. The third section 315 of the male terminal 311 is the part to be accommodated in the female terminal 321, in the state where the male connector 31 and the female connector 32 are mated.

FIG. 7 is an enlarged view of the female terminal 321. In the female terminal 321, the metal plating 322 is formed from a first section 324 of the female terminal 321 to a second section 325 (a base end part) of the female terminal 321. The first section 324 of the female terminal 321 is a part where the grippers 323 of the female terminal 321 hold the male terminal 311, in the state where the male connector 31 and the female connector 32 are mated. The second section 325 of the female terminal 321 is connected to the backboard 2, and electrically connected to the wiring 21 of the backboard 2. The metal plating 322 is not formed on a third section (a leading end part) 326 leading from the first section 324 of the female terminal 321. In other words, the third section 326 of the female terminal 321 is exposed from the metal plating 322. The third section 326 of the female terminal 321 is a non-plated part where the metal plating 322 is not formed.

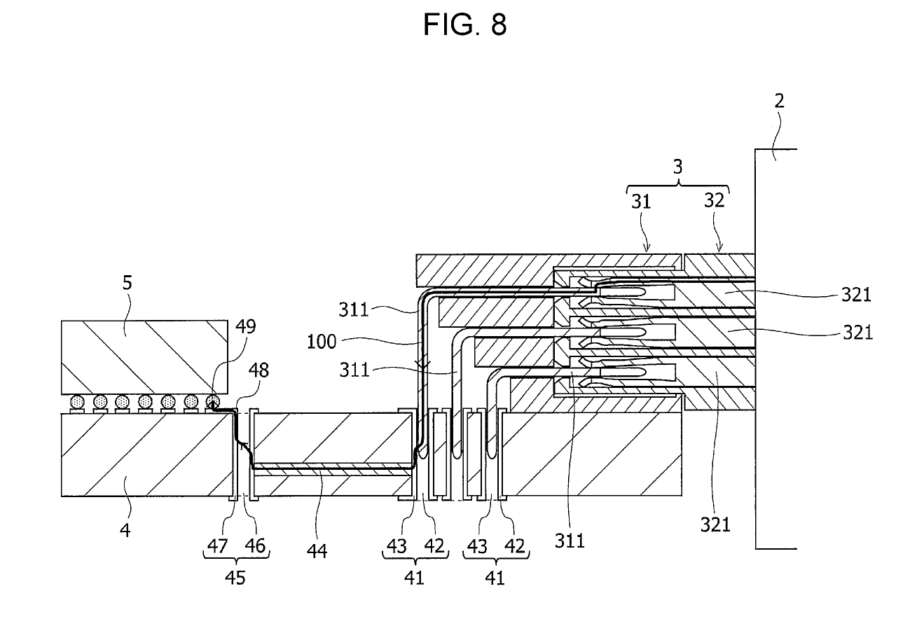

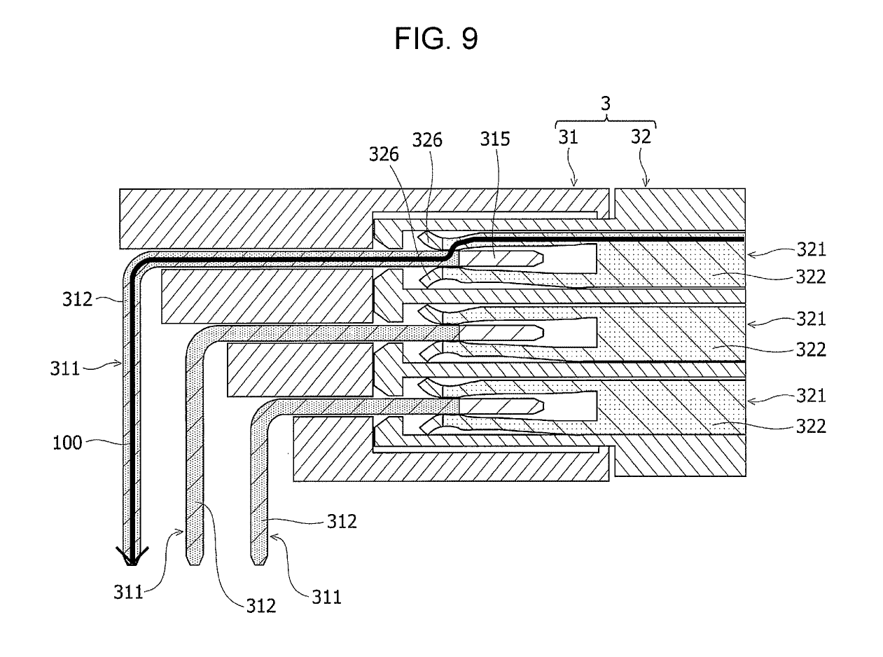

The male terminal 311 and the female terminal 321 are electrically connected by contact between the metal plating 312 formed on the male terminal 311 and the metal plating 322 formed on the female terminal 321. This allows transmission of a signal from the backboard 2 to the electronic component 5, and transmission of a signal from the electronic component 5 to the backboard 2, via the connector 3. FIG. 8 is a diagram schematically illustrating a flow of a signal transmitted from the backboard 2 to the electronic component 5. FIG. 9 is an enlarged view of the connector 3, and schematically illustrates the flow of the signal transmitted from the backboard 2 to the electronic component 5. In each of FIGS. 8 and 9, the flow of the signal is indicated by a bold line 100.

As illustrated in FIGS. 8 and 9, the signal transmitted from the backboard 2 to the electronic component 5 passes through the metal plating 312 formed on the male terminal 311 and the metal plating 322 formed on the female terminal 321. In other words, the metal plating 312 formed on the male terminal 311 and the metal plating 322 formed on the female terminal 321 form a transmission path of the signal. As illustrated in FIG. 9, the signal transmitted from the backboard 2 to the electronic component 5 does not pass through the third section 315 of the male terminal 311 and the third section 326 of the female terminal 321. In other words, the third section 315 of the male terminal 311 and the third section 326 of the female terminal 321 do not form the transmission path of the signal. Therefore, reflection of the signal transmitted by the male terminal 311 and the female terminal 321 is suppressed, and occurrence of noise due to the reflection of the signal and the like is reduced.

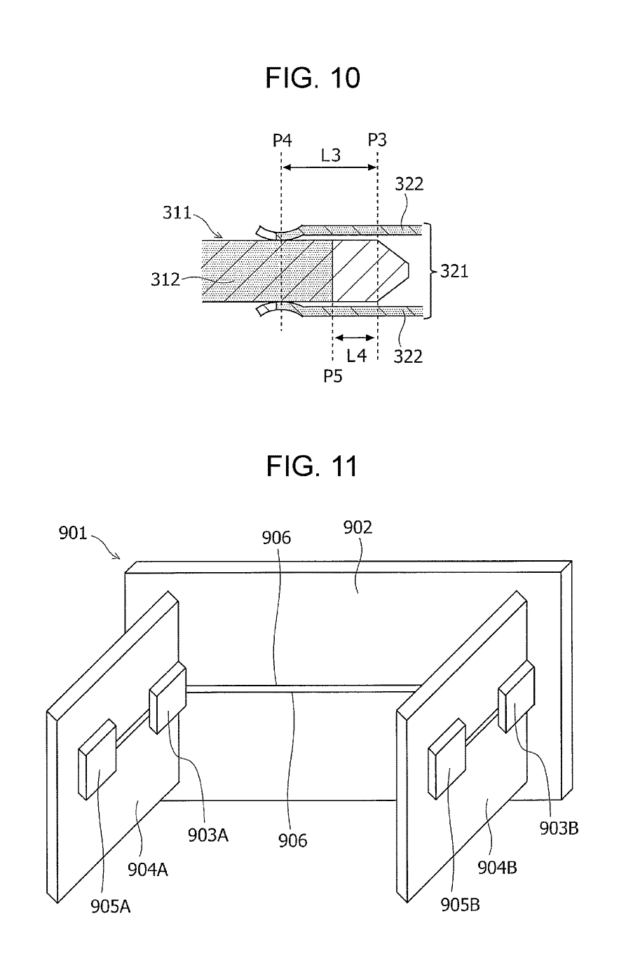

FIG. 10 is an enlarged view of the male terminal 311 and the female terminal 321. A position P3 illustrated in FIG. 10 is a position where the contact between the male terminal 311 and the female terminal 321 begins. A position P4 illustrated in FIG. 10 is a position where the male terminal 311 and the female terminal 321 are in contact with each other in the state where mating of the male connector 31 and the female connector 32 is completed. When a length (a length from the position P3 to the position P4) L3 in the male terminal 311 is 2 mm, the metal plating 312 may be formed on the male terminal 311 from a position P5, in consideration of warping of boards and mechanical deviation. A length L4 from the position P3 to the position P5 is, for example, 0.9 mm.

The material of the male terminal 311 may be a material having conductivity lower than conductivity of the metal plating 312. Examples of the material having the conductivity lower than the conductivity of the metal plating 312 include stainless steel, for example. Electrical resistance of the third section 315 of the male terminal 311 is higher than electrical resistance of the metal plating 312, when the material having the conductivity lower than the conductivity of the metal plating 312 is used for the material of the male terminal 311. For this reason, the reflection of the signal transmitted by the male terminal 311 is suppressed, and the occurrence of the noise due to the reflection of the signal and the like is reduced.

The material of the female terminal 321 may be a material having conductivity lower than conductivity of the metal plating 322. Examples of the material having the conductivity lower than the conductivity of the metal plating 322 include stainless steel, for example. Electrical resistance of the third section 326 of the female terminal 321 is higher than electrical resistance of the metal plating 322, when the material having the conductivity lower than the conductivity of the metal plating 322 is used for the material of the female terminal 321. For this reason, the reflection of the signal transmitted by the female terminal 321 is suppressed, and the occurrence of the noise due to the reflection of the signal and the like is reduced.

The material of the female terminal 321 may be a conductive material. When the material of the female terminal 321 is a conductive material, the metal plating 322 is not formed on the surface of the female terminal 321. As illustrated in FIG. 7, the third section 326 of the female terminal 321 has a short distance and thus, an influence of the reflection of the signal transmitted by the female terminal 321 is small. Therefore, the material of the female terminal 321 may be a conductive material, and formation of the metal plating 322 on the surface of the female terminal 321 may be omitted. When the material of the male terminal 311 is the nonconductive material or the material having the conductivity lower than the conductivity of the metal plating 312, the reflection of the signal transmitted via the connector 3 is suppressed, and the occurrence of the noise due to the reflection of the signal and the like is reduced.

In an apparatus adopting high speed transmission, reflection of a signal increases. According to the connector 3 of the embodiment, the reflection of the signal transmitted by the male terminal 311 and the female terminal 321 is suppressed, and the occurrence of the noise due to the reflection of the signal and the like is reduced, even in the apparatus adopting the high speed transmission. Further, the connector 3 according to the embodiment may be used for a general-purpose inter-board connection connector other than an apparatus used for a network system, a server system, or the like.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A connector comprising:
a first connector that includes a first terminal; and
a second connector that includes a second terminal and is configured to be mated to the first connector,
wherein in a state where the first connector and the second connector are mated, the second terminal holds the first terminal and accommodates a leading end part of the first terminal,
first metal plating is formed above a portion of the first terminal from a part of the first terminal to a base end part of the first terminal, the part being configured to be held by the second terminal, and
the leading end part of the first terminal accommodated in the second terminal is exposed from the first metal plating.

2. The connector according to claim 1, wherein second metal plating is formed above a portion of the second terminal from a part of the second terminal to a base end part of the second terminal, the part being configured to hold the first connector, and
a leading end part of the second terminal is exposed from the second metal plating.

3. The connector according to claim 1, wherein the first terminal is formed of a nonconductive material or a material with conductivity lower than conductivity of the first metal plating.

4. The connector according to claim 2, wherein the first terminal is formed of a nonconductive material or a material with conductivity lower than conductivity of the first metal plating.

5. The connector according to claim 2, wherein the second terminal is formed of a nonconductive material or a material with conductivity lower than conductivity of the second metal plating.

6. A connector comprising:
a first connector that includes a first terminal and is mounted above a first board; and
a second connector that includes a second terminal, is mounted above a second board, and is configured to be mated to the first connector,
wherein in a state where the first connector and the second connector are mated, the second terminal holds the first terminal and accommodates a leading end part of the first terminal,
first metal plating is formed above a portion of the first terminal from a part of the first terminal to a base end part of the first terminal coupled to the first board, the part being configured to be held by the second terminal, and
the leading end part of the first terminal accommodated in the second terminal is exposed from the first metal plating.

7. The connector according to claim 6, wherein second metal plating is formed above a portion of the second terminal from a part of the second terminal to a base end part of the second terminal coupled to the second board, the part being configured to hold the first connector, and
a leading end part of the second terminal is exposed from the second metal plating.

8. The connector according to claim 6, wherein the first terminal is formed of a nonconductive material or a material with conductivity lower than conductivity of the first metal plating.

9. The connector according to claim 7, wherein the first terminal is formed of a nonconductive material or a material with conductivity lower than conductivity of the first metal plating.

10. The connector according to claim 7, wherein the second terminal is formed of a nonconductive material or a material with conductivity lower than conductivity of the second metal plating.

11. A method of mating a first connector that includes a first terminal and is mounted above a first board and a second connector that includes a second terminal and is mounted above a second board, the method comprising:
holding the first terminal and accommodating a leading end part of the first terminal by the second terminal in mating the first connector and the second connector, wherein
first metal plating is formed above a part of the first terminal from a part of the first terminal held by the second terminal to a base end part of the first terminal coupled to the first board, and
the leading end part of the first terminal accommodated in the second terminal is exposed from the first metal plating.
